(19) United States
(12) Patent Application Publication
(10) Pub. No.: US 2026/0119299 A1
(43) Pub. Date: Apr. 30, 2026

(54) COMPUTER-IMPLEMENTED METHOD FOR ARRANGING ERROR REPORTS IN AT LEAST TWO ERROR REPORT GROUPS OF SIMILAR ERROR SITUATION

(71) Applicant: TRUMPF Werkzeugmaschinen SE + Co. KG, Ditzingen (DE)

(72) Inventors: Guillem BOADA, Tübingen (DE); Alexander KAISER, Kusterdingen (DE)

(21) Appl. No.: 19/430,471

(22) Filed: Dec. 23, 2025

Related U.S. Application Data
(63) Continuation of application No. PCT/EP2024/067670, filed on Jun. 24, 2024.

(30) Foreign Application Priority Data
Jul. 3, 2023 (DE) 10 2023 117 503.3

(51) Int. Cl. G06F 11/07

(52) U.S. Cl. CPC G06F 11/0781; G06F 11/0706

(57) ABSTRACT

A method for arranging error reports into at least two error report groups of different error situations, the method including reading in error reports each with at least two error report attachments of different domains and determining a similarity operator for at least two of the different domains to determine a similarity between error report attachments of the same domain. The method also includes determining similarity values of the error report attachments of the same domain by comparing individual error report attachments of the same domain from different error reports by the determined similarity operator. The method also includes grouping the error reports into the at least two error report groups of different error situations based on the determined similarity values.

### CROSS REFERENCE TO RELATED APPLICATIONS

This application is a continuation of International Application No. PCT/EP2024/067670 (WO 2025/008218 A1), filed on Jun. 24, 2024, and claims benefit to German Patent Application No. DE 10 2023 117 503.3, filed on Jul. 3, 2023. The aforementioned applications are hereby incorporated by reference herein.

### FIELD

The invention relates to a computer-implemented method for arranging error reports in at least two error report groups of similar error situations, as well as an associated computer program product, group-forming system, and system comprising the group-forming system and at least one test system.

### BACKGROUND

A test system is a system which issues an error report. The test system may be represented by a computer program that can be executed by a corresponding processor, in particular on a production system, a development system, a backup system, or a quality assurance system.

The use of computer programs or software is indispensable for numerous technical products, as it has become an integral part of these products. This is the case, for example, with machines used in industry, in particular machine tools, which require one or a plurality of computer programs to perform their functions. For example, these can be machine tools which use laser technology for metalworking tasks and chip lithography, which often involve particularly complex software applications.

The technical products, including their associated computer programs, may be faulty and generate corresponding error messages. Error messages may also be false alarms, i.e., without there being a product fault or without a real error in the use of the product, e.g., the machine tool, or in the computer program. In order to provide the products with as few errors as possible, they are tested in advance.

Testing is the process of interacting with the product to check whether it meets the requirements and is free from product faults that could affect its functionality. The aim is to decide whether the product can be released or not. For small products, testing can be successfully performed manually; however, as the size and complexity of the product increases, in particular for the aforementioned machine tools, the size of the system state space grows exponentially, making this task no longer feasible manually. In this case, it is advisable to carry out automatic testing of the product using a computer-based test system.

For example, automated tests themselves are error-prone, and each failed test requires manual review to verify its result, i.e., to classify its cause as either a product fault or a false alarm. False alarms are due to testing and infrastructure problems and not defects in the product itself. Developers must examine error reports, which include error messages, stack traces and log files, to perform this verification.

It is known from the prior art to automate test methods. US 2021/0287109 A1 describes a computer-implemented method for analyzing test errors using an AI model. The method first involves clustering, in which test errors are clustered into individual error clusters. The clustering result is then used to train the AI model in order to automatically identify the cause of new, unclassified errors.

Although the methods known from the prior art can be used for error detection or identification, they are not suitable for preventing product faults to the extent that would be desirable. For example, it has been found that many error messages, whether false alarms or product faults, are not analyzed in the known testing methods. This means that errors can remain in the product and only become apparent later at the customer's premises, leading to complications. Such errors often require a very complex and time-consuming process of resolving them through a new test phase. For example, if a machine tool with various product faults is delivered to a customer after a supposedly successful test phase, downtimes caused by product faults can cause major production losses for the customer.

### SUMMARY

In an embodiment, the present disclosure provides a method for arranging error reports into at least two error report groups of different error situations, the method comprising reading in error reports each with at least two error report attachments of different domains and determining a similarity operator for at least two of the different domains to determine a similarity between error report attachments of the same domain. The method also comprises determining similarity values of the error report attachments of the same domain by comparing individual error report attachments of the same domain from different error reports by the determined similarity operator. The method also comprises grouping the error reports into the at least two error report groups of different error situations based on the determined similarity values.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic view of a method according to an exemplary embodiment of the present disclosure;

FIG. 2 illustrates a schematic view of a part of the method of FIG. 1 according to an exemplary embodiment of the present disclosure;

FIG. 3 illustrates a schematic view of a part of the method of FIG. 1 according to an exemplary embodiment of the present disclosure;

FIG. 4 illustrates a schematic view of a part of the method of FIG. 1 according to an embodiment of the present disclosure; and

FIG. 5 illustrates a schematic view of a system according to an exemplary embodiment of the present disclosure, comprising a group-forming system according to an exemplary embodiment of the present disclosure and a plurality of test systems.

### DETAILED DESCRIPTION

In an embodiment, the present disclosure provides for increasing the reliability of the products, in particular a particularly robust computer-implemented method for grouping error reports in order to increase product reliability.

The foregoing is achieved by a computer-implemented method for grouping error reports into at least two error report groups of different error situations. The method comprises at least the following steps:
reading in error reports each with at least two error report attachments of different domains,
determining a similarity operator for each of the different domains to determine a similarity between error report attachments of the same domain,
determining similarity values of the error report attachments of the same domain by comparing individual error report attachments of the same domain from different error reports by means of the previously determined similarity operator, and
grouping the error reports into the at least two error report groups of similar error situations based on the previously determined similarity values.

The method according to the present disclosure is therefore based on the fact that the error reports are processed separately in their individual components, i.e., with their error report attachments. To achieve this, different similarity operators are determined and used for the different domains in which the error report attachments are provided. Thus, the method according to the present disclosure can access the maximum amount of error-relevant information from the error reports in order to enable the error reports to be assigned to different error situations by comparing similarities and grouping. Finally, it was recognized that a comparison of the error reports as a whole does not achieve the desired high level of robustness because the data cannot be compared with the same level of accuracy as is possible with the different similarity operators according to the present disclosure. Furthermore, when comparing individual error report attachments of the same format from the error reports, important error information may be overlooked, making robust grouping impossible. By using the similarity values of error report attachments for grouping, as much error information as possible can be used for robust error report grouping.

The different error report attachments can be differentiated from each other based on their domain. The domain defines in particular the context and/or format of the information contained. Thus, for example, the same formats, in particular file formats, can be present, yet still belong to different domains. For example, in an image format in context view, different images can be provided as error report attachments, such as a screen capture of a test sequence, on the one hand, and a photo of a machined workpiece, on the other. Because of the different context, different domains are present here, even if the file format may be identical. On the other hand, with the same context, for example, on the one hand, a screen capture of a test sequence at an error output time and, on the other hand, an error text at the error output time, different formats, in particular file formats, can be present, such that different domains can also exist. To determine the similarity of error report attachments of different formats in the same context, it is made possible to convert the error report attachments into a common format. To do this, one error report attachment can be converted to the format of the other error report attachment, or both error report attachments can be converted to a third format. For example, different image formats or video formats can be harmonized.

The error reports can each be issued by one test system, although a plurality of test systems can also be used. Error reports can indicate an error, which can be expressed in particular by an error message. The products tested are in particular machines, such as machine tools, or computer programs or software applications which are executed on the machines. A corresponding test sequence or a system test of the test system can be carried out by a computer, in particular a processor, of the machine in question. The test system can be represented by a computer program that can be executed by a corresponding processor, in particular on the product. The test system thus enables, for example, a test of the functionality of the product in terms of its functionality or with regard to possible errors at least with regard to one or a plurality of computer programs that can be executed on the product. The test system also enables, for example, a service or service check of the product. The test can be designed in particular as a UI (user interface) test, in particular a GUI (graphical user interface) test, which can run on a corresponding system screen. The result of such an exemplary test sequence is the error report with its error report attachments of different domains, which can be understood as individual components of the error report. In particular, the error report attachments can be separate files of different domains, in particular different file formats. The method according to the present disclosure can of course also involve the step of testing or a test sequence itself, in particular in the form described above.

The similarity value is a value regarding a similarity between two error report attachments, which can correspond in particular to the human intuitive concept of similarity. In particular, this is a real value which can be restricted, for example, to an interval such as the unit interval, i.e., [0, 1], or a Boolean value. In particular, the similarity value can be symmetrical to ensure that the similarity between two error report attachments is always the same, regardless of the order in which they are determined using the similarity operator. Given a dataset of error report attachments of the same format, the similarities between all error report attachments can be calculated using the similarity operator specific to the format, which can in particular include or consist of one or a plurality of similarity functions, and are represented, for example, in a similarity matrix. In particular, different similarity operators are determined and used for different formats in order to provide the most accurate similarity results possible and thus enable robust grouping of the error reports. Examples of possible similarity operators will be explained in more detail later with reference to examples of possible domains.

Once the similarity values of the error report attachments have been determined, it can be indicated for each individual error report attachment which error report attachments of error reports with which it has been compared it is the same as or most closely similar to, in order to enable an assignment or grouping of error report attachments with the same or similar error situation. An error situation is understood to mean at least one error or a combination of a plurality of errors that are the same as or similar to one another. This refers in particular to the cause of the error, for example due to faulty programming in a specific part of the computer program executed by the test system, a specific category of hardware errors, etc. In order to group or, in other words, cluster the error reports, the similarity values determined in each case are used, in particular by comparing the similarity values with each other. Various grouping operations are made possible here.

For example, it can be provided that the similarity values are compared with a grouping logic in order to group the error reports into the at least two error report groups. For example, to compare two error reports, the similarity values of the error report attachments of the same domain can be compared with individual grouping thresholds of the grouping logic, and for each similarity value, the defined grouping threshold can be used to determine whether there is sufficient similarity to assign the error report attachments to the same error situation. Alternatively or additionally, the individual similarity values can be combined to form an overall similarity value of the grouping logic with subsequent comparison against an overall grouping threshold value. Only if the overall grouping threshold is met by the overall similarity value, the two error reports are grouped into the same error report group. However, the grouping logic can also be designed as a maximum value or a maximum requirement, for example, such that the maximum of individual similarity values or overall similarity values of an error report with its compared error reports is used for grouping. This ensures, if necessary, that each error report is grouped into only one error report group and that the sensitivity of a selected grouping threshold is not set too low or too high. In particular, an artificial intelligence (AI) model, especially one based on machine learning, can be used to continuously improve the grouping. Through machine learning, the AI model can select an increasingly optimized grouping logic, for example grouping thresholds, in particular different grouping thresholds for different error situations.

It can be provided that, when determining the similarity values, error report attachments of already grouped error reports are compared with read-in, not yet grouped error report attachments by means of the respective previously determined similarity operator. This allows an existing database of already grouped error reports to be referenced, so that not only the currently read-in error reports are compared with each other, but also previously identified error report groups associated with specific error situations can be used and expanded. This also allows new error situations to be quickly identified if an error report cannot be grouped into any previously created error report group, particularly taking the grouping threshold into account, so that a new error report group can be created.

It can also be provided that the error reports are multimodal and that the different domains are different formats, in particular different media formats. Accordingly, it is not only text files that need to be compared to determine their similarity to one another. This requires special similarity operators for the different media formats. Metadata of the error report attachment can also be considered as a possible domain, in particular the format of an error report attachment.

In particular, the different media formats can be from the group comprising a text file, in particular an error message, log file and/or stack trace, image file, video file and/or audio file.

The error message as a sub-format of the text file is in particular a very short, unchangeable, and unambiguous sentence that accompanies an error. When an error is triggered, this text portion is also returned as a note to the developer about the source of the error. In some cases, these messages are very informative about the cause of the error, such as “Access denied” or “The parameter is incorrect,” while in other cases they are a general statement which may have been caused by numerous events, such as “The time limit has elapsed and the operation was not completed.” In this case, nothing is known about the process, only that it was not completed.

The text file can also be assigned the stack trace sub-format, which can contain very relevant information about error messages. This is because a program used for testing usually consists of functions which interact with each other through calls and requests. If an error occurs in one of these functions, the runtime environment throws an exception. In some cases, the program is prepared to intercept these and continue running. However, exceptions that are not intercepted will cause the program to crash. However, the single error and the associated error message are often not enough to determine the cause of the problem. In this case, the stack trace proves useful as it provides more details about the source of the unintercepted error. It collects the stack of functions called up to the point where the error was triggered. This makes it possible to identify the problem in the code. Stack traces can thus be very informative about an error.

Another important sub-format of the text file is the log file. A large number of events and operations take place during a test run. Although most of them occur routinely in the system, some can be used to identify the cause of a specific problem. Log files are machine-generated files that record all of these activities. They can also be described as containers with extensive and diverse information that can be valuable for error troubleshooting. Although there are no standards for their format and size, they are typically structured in entries, with each entry comprising one or more lines and reporting a specific event along with a timestamp indicating the exact time of the event and, if necessary, even identification numbers and paths. The length of the log files in the dataset varies greatly. The log file length depends directly on the type of test. Some tests are very short and simply start and stop the test sequence, while others are longer and perform several consecutive sub-tests to test the endurance of the product. Among the multitude of existing log files, frontend and backend log files are preferred for analysis, as they have proven to be particularly informative for machines, in particular machine tools. These files are similar in format but differ in the information they contain. The frontend log is responsible for capturing events on the user interface of the machine under test or its processor, while the backend log collects information about the process in the backend of the same processor. It is understood that a large number of processes can be executed on the machine and, accordingly, a large number of log files can be output by the test system.

The image file can be a screen capture of a test sequence for the error report at an error output time. The video file can be a screen recording of the test sequence for the error report. In particular when conducting GUI tests, the system screen can be recorded to create a video that can be saved in an appropriate file format, for example as an MP4, AVI file or the like. Such a video can be crucial in identifying the problematic event that led to the test failure. In order to conserve the limited amount of data storage available, it can also be sufficient if only one or more screen captures are created as error report attachments at and/or shortly before and/or after the error output time and taken into account or read in during the method. Screen capture and screen recording can also be considered together as error report attachments in order to be able to evaluate the largest possible dataset for grouping.

Finally, it can also be provided that the formats comprise different text formats of text files. The text formats can refer to the previously mentioned different sub-formats, which are determined by the type of the sub-format, such as an error message, log file and/or stack trace. However, they can alternatively or additionally refer to different formats within formats or sub-formats of the same type, for example different formatting of frontend log files and backend log files.

Different similarity operators can be determined for different formats, in particular media formats. For example, a Levenshtein edit distance can be determined for stack traces. This approach is based on the fact that although there is a precise mathematical definition of similarity, it is in a sense the inverse of a distance measure. This makes it possible to derive a similarity from a distance measure. Since distance measures have some well-defined properties, a distance can be calculated instead of a similarity measure. For log files, for example, the Jaccard similarity calculation can be used as a similarity operator. This metric quantifies the similarity between two sample sets. It is equal to the ratio between the number of elements in the intersection and the union of these sets. This means that the more elements they have in common, the greater the similarity. For video files and other media formats, for example, a cosine similarity can be determined. Given two objects A and B, each represented as a vector, the cosine of the deviation between these two vectors is the cosine similarity or, in other words, Ochiai or Carbo similarity.

However, several similarity operators can be provided or can be determined for the same domains, wherein one of these several similarity operators can be selected for the respective domain or a comparison can be carried out with different similarity operators for the same domain.

The result of the error report groups can be used in many ways, wherein this use can be another component of the method. For example, the result can be transmitted to the test system(s) executing the test sequence to improve the testing, in particular in the form of a machine learning algorithm, to the product(s) being tested, for example to output or display the specific error situation on a corresponding screen or a control element of the product, to a service technician for the elimination of error situations, etc., and used by this or these test system(s).

It can also be provided that at least one group-based metric is determined for each error report group, in particular a ratio of a number of log files of one of the error situations to a total number of log files. This metric makes it very easy to determine the most common error situation. Preferably, this metric is applied to the log files of a predetermined period of time, e.g., the log files of the last week. An error situation can describe both a product fault and a false alarm. The metric can therefore be used to determine the most frequently occurring product faults and false alarms. This allows developers' work to be prioritized.

The method can also further comprise the step of summarizing the error reports of at least one of the error report groups into a group error report. Thus, only one single group error report remains, in particular one which is aggregated with respect to its error information. The aggregated group error report can help resolve errors faster because it contains only the most important or necessary error information and does not contain data which is unnecessary for error investigation.

In addition, the method can further comprise the step of determining an error criticality of the error report groups and in particular prioritizing the error report groups according to the determined error criticality. In other words, an error severity of the error report groups is determined. For example, error criticality can be determined based on one or more of the previously mentioned metrics. This allows for prioritization of error troubleshooting in order to make the product, for example the machine tool, functional and error-free again as quickly as possible.

Finally, it can also be provided that machine learning is used in determining a similarity operator, in determining the similarity values and/or in grouping the error reports. As already mentioned, a corresponding AI model can thus increase the robustness of the method, for example by better determining similarity operators and grouping thresholds.

The above-mentioned advantages are further achieved by a computer program product according to the present disclosure. The computer program product comprises commands which, when the computer program product is executed by a computer, cause the latter to execute the method according to the present disclosure.

The computer program product can be a computer program as such or a computer-readable storage medium on which the computer program or its commands are stored. The storage medium can be a tangible device which can store and retain commands for use by a command execution device, i.e., a computer, in particular a processor. The computer-readable storage medium can be, for example, but is not limited to, an electronic storage device, a magnetic storage device, an optical storage device, an electromagnetic storage device, a semiconductor storage device, or any suitable combination of the above devices. A non-exhaustive list of more specific examples of a computer-readable storage medium comprises the following: a portable computer diskette, a hard disk, random access memory (RAM), read-only memory (ROM), erasable programmable read-only memory (EPROM or flash memory), static random access memory (SRAM), portable compact disk read-only memory (CD-ROM), a digital versatile disk (DVD), a memory stick, a floppy disk, a mechanically encoded device such as punched cards or raised structures in a groove with commands recorded thereon, and any suitable combination of the above. As used herein, a computer-readable storage medium should not be understood to mean transitory signals per se, such as radio waves or other freely propagating electromagnetic waves, electromagnetic waves propagating through a waveguide or other transmission medium (e.g., pulses of light traveling through a fiber optic cable), or electrical signals transmitted through a wire.

The computer-readable program instructions described herein can be downloaded from a computer-readable storage medium to the respective computing/processing devices or to an external computer or external storage device over a network, such as the Internet, a local area network, a wide area network, and/or a wireless network. The network can comprise copper transmission cables, optical transmission fibers, wireless transmission, routers, firewalls, switches, gateway computers, and/or edge servers. A network adapter card or network interface in each computer/processing device receives computer-readable program instructions from the network and forwards the computer-readable program instructions for storage in a computer-readable storage medium within the respective computer/processing device.

The computer-readable program instructions for performing operations within the scope of the present disclosure can be assembly commands, command set architecture (ISA) commands, machine commands, machine-dependent commands, microcode, firmware commands, state data, integrated circuit configuration data, or either source code or object code written in any combination of one or more programming languages, including an object-oriented programming language such as Smalltalk, C++, or the like, and procedural programming languages such as the C programming language or similar programming languages. The computer-readable program instructions can be executed entirely on the user's computer, in part on the user's computer, as a stand-alone software package, in part on the user's computer and in part on a remote computer, or entirely on the remote computer or server. In the latter case, the remote computer can be connected to the user's computer over any type of network, including a local area network (LAN) or a wide area network (WAN), or the connection can be made to an external computer (e.g., over the Internet using an Internet service provider). In some embodiments, electronic circuits, comprising, for example, programmable logic circuits, field programmable gate arrays (FPGA), or programmable logic arrays (PLA), can execute the computer-readable program instructions by using state information of the computer-readable program instructions to personalize the electronic circuits to perform aspects of the present disclosure.

The above-mentioned advantages are also achieved by a group-forming system according to the present disclosure. A group-forming system according to the present disclosure comprises a memory and a processor connected to the memory, wherein the computer program product according to the present disclosure is stored on the memory and the processor is configured to execute the commands of the computer program product.

The group-forming system can have at least one interface to at least one test system, wherein the at least one test system is configured to generate error reports each having at least two error report attachments of different domains.

Finally, the advantages mentioned at the outset are achieved by a system comprising the group-forming system according to the present disclosure and the at least one test system.

Features described herein with respect to the method according to the present disclosure apply equally to the computer program product according to the present disclosure, the group-forming system and the system, and vice versa.

Further details and advantageous configurations of the present disclosure can be found in the following description, on the basis of which exemplary embodiments of the present disclosure are described and explained in greater detail.

In the following description and the figures, the same reference signs are used in each case for identical or mutually corresponding features.

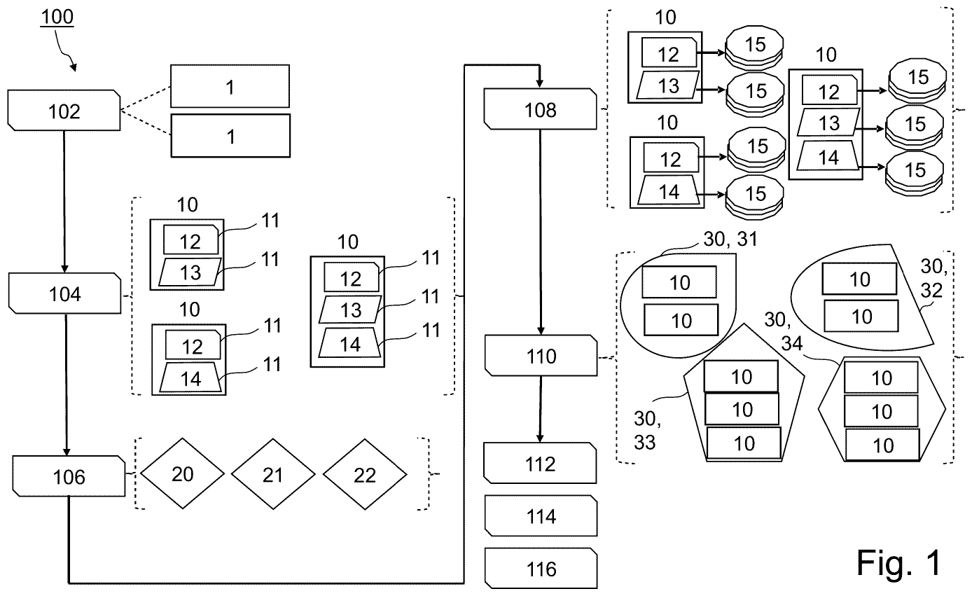

FIG. 1 schematically shows a computer-implemented method 100 for grouping error reports 10 into at least two error report groups 30 of different error situation 31, 32, 33, 34, i.e., that the error report groups 30 each have different error situations 31, 32, 33, 34 with respect to their error reports 10 grouped therein.

A step 102 attributable to the method 100 or separate therefrom is the testing itself or the test sequence or system test. For this purpose, products are tested using test systems 1. Purely as an example, two test systems 1 are tested here, although of course there can be significantly more than two test systems 1 or even just a single test system 1. Each of the test systems 1 can be applied to one or more products, e.g., a machine tool with the computer program(s) or software applications located thereon or, alternatively, the computer program as such. The testing in step 102 can otherwise be carried out according to known principles, in particular as an automated testing of the respective test system 1. For example, GUI tests can be used. Each system test results in an error report 10. The error report 10 can contain errors.

In the following step 104, the error reports 10 generated in the test sequence of the step 102 are read in. In particular, only those error reports can be read which actually contain errors, since only these contain an error message and are relevant for error analysis in order to increase the robustness of the products.

The error reports 10 each comprise two or more error report attachments 11, as shown schematically in FIG. 1. These error report attachments 11 can be of different domains 12, 13, 14, in particular of different formats, as illustrated in FIG. 1 by way of example for three different formats 12, 13, 14, although of course more different formats 12, 13, 14 can exist and be distinguished.

The following description refers to different formats 12, 13, 14 as a special embodiment of the different domains 12, 13, 14. In principle, however, different domains can not only have different formats, they can also have the same format but refer to a different context or contain different context information. An example of the same file format with different context information and thus different domains is a video file as a recording of a screen during the execution of a test and a video file as a recording of a laser cutting process of a workpiece.

The different formats 12, 13, 14 can, for example, be different text formats of error report attachments 11 in the form of text files, for example differently formatted log files, stack traces, error messages, etc. The formats 12, 13, 14 can, in particular, be different media formats, such as text files, image files, video files, and/or audio files. For example, the image files can be screen recordings or screen captures of the test sequence, in particular in the case of a GUI test, at the time of the error. For example, the video files can be video recordings of the system screen of the test system 1 executing the test or its computer, in particular in the case of a GUI test, wherein the video comprises at least a period of time at and/or shortly before and/or shortly after the time of the error. In this respect, the error reports 10 and their error report attachments 11 can be described as multimodal.

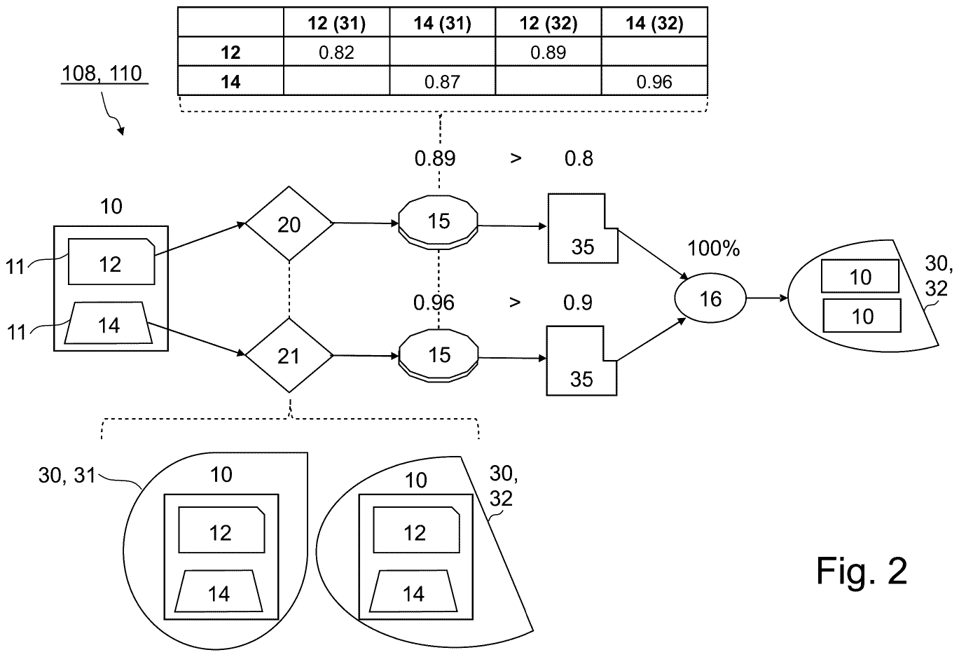

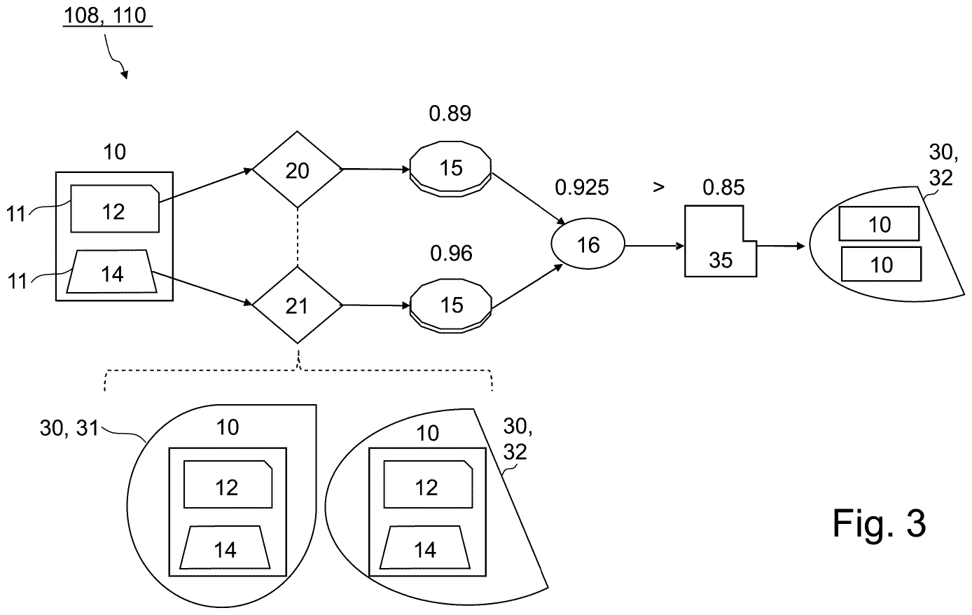

In the step 106 of the method 100, an associated similarity operator 20, 21, 22 is determined for each of the different formats 12, 13, 14. Exemplary similarity operators 20, 21, 22 can be, for example, specialized edit distances for stack traces, Jaccard similarities of text content or text files and cosine similarities for other content, in particular image and video files. The similarity operator 20, 21, 22 is determined in such a way that it identifies error report attachments 11 with similar error situations. In other words, the similarity operator 20, 21, 22 can be used to determine how similar two error report attachments 11 are to each other (by calculating a similarity value 15). This will be explained later in an exemplary and clear manner with reference to FIGS. 2 and 3.

In the step 108 of the method, similarity values 15 between the error report attachments 11 are determined by a comparison between error report attachments 11 each having the same format 12, 13, 14 and by means of the similarity operator 20, 21, 22 associated with the respective format 12, 13, 14. The respective similarity values 15 of an error report attachment 11 indicate the similarity for the specific error report attachment 11 of a format 12, 13, 14 compared to various other error report attachments 11 of the same format 12, 13, 14. In particular, similarity matrices can be created in this way.

As shown in FIGS. 2, 3 and 4, the read-in error report attachments 11 are compared in particular with previously read-in or saved error report attachments 11 of the same format 12, 13, 14. These stored error report attachments 11 can in particular originate from previously grouped error report groups 30, so that each of these stored error report attachments 11 has already been assigned one of the various four error situations 31, 32, 33, 34 shown purely by way of example in FIG. 1 based on the grouping into the respective error report group 30.

After the step 108, the information is now available as to which error report attachment 11 of an already grouped error report 10 of a specific error situation 31, 32, 33, 34 a respective error report attachment 11 of a specific format 12, 13, 14 of the read-in error report 10 can be assigned.

However, the error report attachments 11 are not considered separately for the grouping, but in step 110 of the method 100, a grouping of the error reports 10 as a whole is carried out on the basis of the similarity values 15 of the error report attachments 11 of each error report 10. Thus, in the step 110, the entire error report 10 can be assigned to a specific error situation 31, 32, 33, 34. At the same time, it was advantageous to make a particularly precise comparison of the individual error report attachments 11 of the same format 12, 13, 14. By also taking into account error report attachments 11 of different formats 12, 13, 14 and comparing them with each other using the respective similarity operators 20, 21, 22, it is ensured that no information regarding error messages from the error reports 10 remains unconsidered. It can happen that an error report attachment 11 of a certain format 12, 13, 14 does not contain an error message or information on this matter, while an error report attachment 11 of a different format 12, 13, 14 of the same error report 10 does contain information on this matter. In this way, the robustness of the method 100 and consequently of the respective product can be significantly increased.

In the step 110, the error reports 10 are now grouped into the individual error report groups 30 with the different error situations 31, 32, 33, 34, wherein error reports 10 which are similar with regard to the error situation 31, 32, 33, 34 are grouped into the respective error report group 30. This grouping is based on the previously determined similarity values 15 of the imported error report attachments 11 of each error report 10.

The result of the error report groups 30 can now be used in a variety of ways, wherein the optional steps 112, 114 and 116 are shown as an example in the further course of the method 100 in order to increase the possible uses.

For example, the result can be transmitted to the test system(s) 1 to improve the testing, in particular in the form of a machine learning algorithm, to the product(s) being tested, for example to output or display the specific error situation on a corresponding screen or a control element of the product, to a service technician for the elimination of product faults, etc., and used by this or these test system(s).

For the step 112, for example, it is provided that for the error report groups 30 of different error situations 31, 32, 33, 34, at least one group-based metric is determined, in particular a ratio of a number of log files 10 of one of the error situations 31, 32, 33, 34 to a total number of log files 10.

For the step 114, it is provided that the error reports 10 in the error report groups 30 are summarized into a group error report with aggregated information regarding the respective error situation 31, 32, 33, 34, for example, error cause, frequency, image, etc. As a result, only a single, aggregated group error report exists. This allows for faster error resolution, for example.

For the step 116, it is provided that an error criticality or, in other words, error severity, of the error report groups is determined. It can also be provided to prioritize the error report groups 30 according to the specific error criticality. For example, error criticality can be determined based on one or more of the previously mentioned metrics. This allows for prioritization of error troubleshooting in order to make the product, for example the machine tool, fully functional and error-free again as quickly as possible.

In addition, the database created from the error report groups 30 can be easily searched for specific error situations 31, 32, 33, 34 in order to quickly classify new, possibly previously unknown error situations.

FIG. 2 now shows a schematic detailed view of the steps 108, 110 of the method 100 from FIG. 1 with respect to an error report 10, which here has, by way of example, two error report attachments 11. The error report attachments 11 can be read directly or edited beforehand to be used in the method 100. For example, if image files are used as the file format of the error report attachments 11, the error report attachments 11 can be vectorized beforehand.

By means of the similarity operator 20, 21 determined for each of the formats 12, 14 of the error report attachments 11 of the read-in error report 10, the determination of similarity values 15 for each compared pair of error report attachments 11 is then carried out by comparison with error report attachments 11, in particular error reports 10 (here purely as an example for the sake of clarity, only two are shown) which are already grouped into the error report groups 30 (here purely as an example of the error situations 31, 32).

In this example, there are now four similarity values 15, as illustrated in the table with example values shown in FIG. 2. In the left column, the error report attachments 11 of formats 12 and 14 of the imported error report 10 are printed in bold, while in the upper column the error report attachments 11 of formats 12, 14 of the already grouped error reports 10 are printed (recognizable and distinguishable by the assignment of the respective error situation in parentheses). Each similarity value 15 now represents how similar the respective error report attachments 11 are relative to each other. As can be seen, in this example, the error report attachments 11 of the read-in error report 10 are more similar to the error report attachments 11 of the error report 10 grouped in the error report group 30 of the error situation 32 than to the error report attachments 11 of the error report 10 grouped in the error report group 30 of the error situation 31, because they each have a higher similarity value 15.

In this example of the step 110, the highest similarity values 15 of all compared error report attachments 11 of the same format 12, 14 are used. By way of example, the values here are 0.89 for the error report attachment 11 of the imported error report 10 of format 12 and 0.96 for the error report attachment 11 of the imported error report 10 of format 14. Now a comparison of the respective highest similarity values 15 is carried out with a respective grouping logic 35, in this case in the form of a comparison with a grouping threshold, which is chosen differently for each of the formats 12, 14, here for example 0.8 and 0.9.

In the example of FIG. 2, the highest similarity values 15 are each greater than the respective grouping thresholds, so that an overall similarity value 16 of 100% (2/2 similarity values 15 above respective grouping thresholds 35) is determined for the error report 10. A further grouping threshold of the grouping logic 35 can now also be compared with this overall similarity value 16, which must be 100%, for example, so that each of the grouping thresholds for the similarity values 15 must be reached by the highest similarity values 15. Accordingly, the error report 10 can now be grouped into the associated error report group 30 based on its error pattern, which here corresponds to error situation 32 as an example.

Furthermore, error report groups 30 of different error situations 31, 32 can be combined or merged in the course of the method 100 if it emerges from the individual error report attachments 11 that these relate to similar error situations 31, 32, for example if error report attachments 11 can be assigned to the same error report groups 30. A new error report group 30 of a different error situation 33, 34 (see FIG. 1) can also be created if one or more error report attachments 11 cannot be assigned to any of the previous error report groups 30 according to the grouping logic 35.

FIG. 3 shows an alternative example of the steps 108, 110 of the method 100, wherein the same exemplary error reports 10 as in FIG. 2 with the same similarity values 15 are used in the example. The overall similarity value 16 is determined from the two highest similarity values 15, here as an example, as the mean value, and then compared with a grouping threshold value of the grouping logic 35 for the overall similarity value 16, which is 0.85 here, for example. Depending on the comparison, positive in this case, since the grouping threshold 35 is exceeded by the overall similarity value 16, the error report 10 is then grouped into the error report group 30 of the error situation 32.

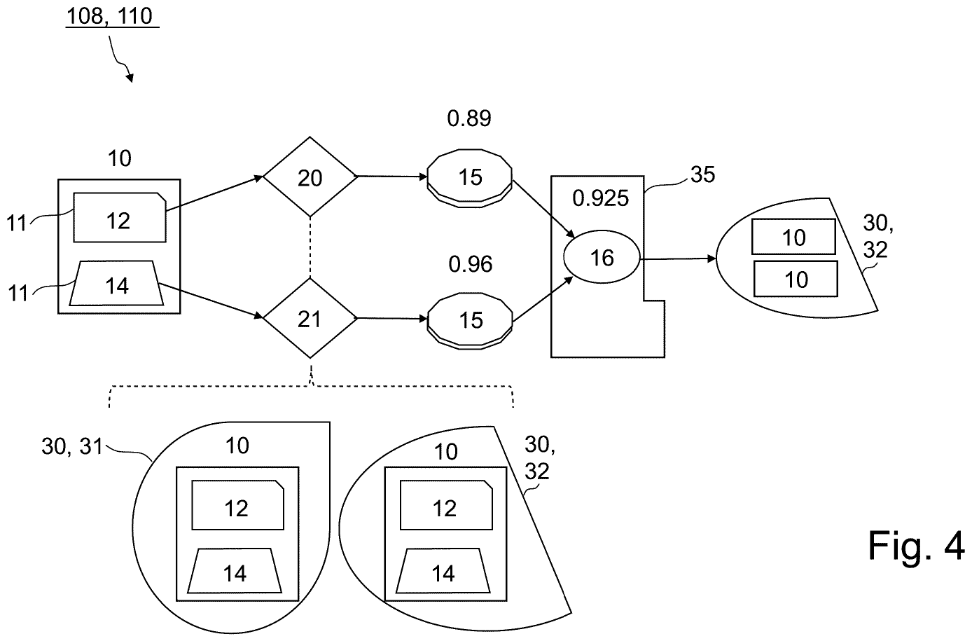

FIG. 4 again shows an alternative example of the steps 108, 110 of the method 100, wherein the same exemplary error reports 10 as in FIG. 2 with the same similarity values 15 are used in the example. Here, the grouping logic 35 is designed as a maximum requirement or condition that the error report 10 with the greatest overall similarity mean 16, here 0.925 for the error report 10 of error situation 32 and 0.855 for the error report 10 of error situation 31 (see FIG. 2), is assigned to the respective associated error report group 30, here again to error situation 32.

The steps 108, 110 shown in FIGS. 2 and 3, including the operations relating to the similarity values 15, the overall similarity value 16, and the grouping logic 35, are preferred but exemplary only. Of course, other operations can also be provided by which overall similarity values 16 are determined from similarity values 15 and other grouping logics 35 can also be provided, so that the examples given here are merely exemplary and in no way restrictive. What is crucial, however, is that similarity values 15 for the error report attachments 11 are determined, then aggregated to the error report level, for example as the overall similarity value 16, and finally the grouping is carried out, wherein one or more grouping thresholds can, for example, be used within the framework of the grouping logic 35.

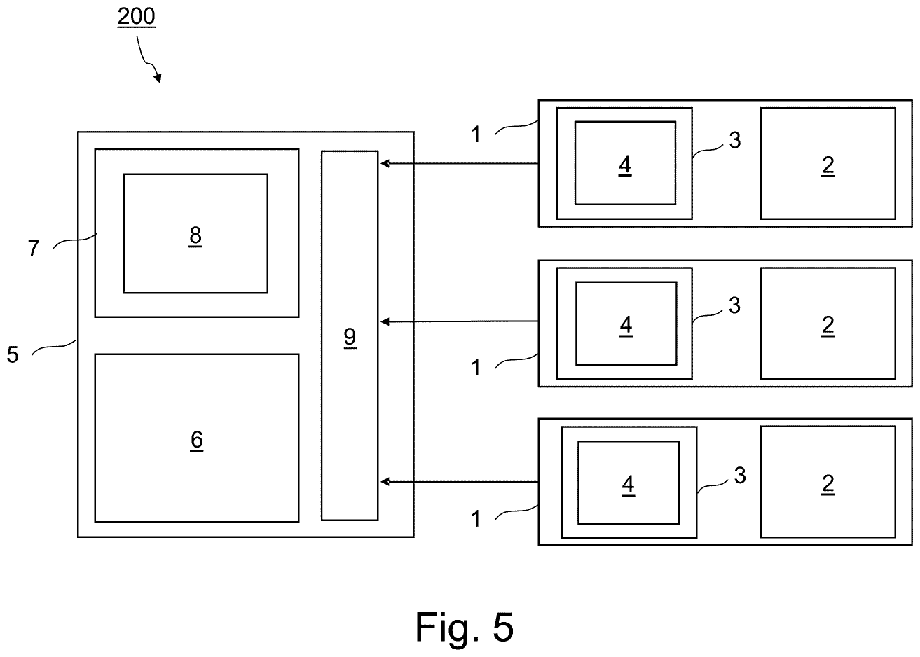

Finally, FIG. 5 schematically shows a system 200 which shows a group-forming system 5 according to an exemplary embodiment of the present disclosure. The group-forming system 5 in the present case comprises a processor 6 and a memory 7 on which is stored a computer program product 8 comprising commands which, when the computer program product 8 is executed by the processor 6, cause said processor to execute the method 100 according to FIG. 1.

In order to carry out the method 100, the computer program product 8 requires the error reports 10 of the test system(s) 1. The test system(s) 1 are part of the shown comprehensive system 200, which also comprises the group-forming system 5. The group-forming system 5 has an interface 9 through which it can receive the error reports 10 from the test systems 1. Of course, the test systems 1 can comprise a corresponding interface for data communication. For physical interfaces, transmission can be wired or wireless, for example. The test systems 1 each have a test processor 2 and a test memory 3 on which a test computer program 4 for carrying out step 102 of the method 100 is stored. The test system(s) 1 can be the products themselves, with the test computer program 4 being executed thereon in order to test the products or the computer programs thereof.

As an alternative to the illustration in FIG. 5, the test system 1 and the group-forming system 5 can also be executed on one of the two systems 1, 5, for which purpose only one memory 7 and one processor 6 can be provided, wherein both computer programs 4, 8 can be stored on the memory 7. One of these two systems 1, 5 can also be formed by the respective product, in particular the machine, so that the method 100 according to the present disclosure can also be carried out partially or completely directly on the product. The interface 9 can also be implemented by computer program code.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for arranging error reports into at least two error report groups of different error situations, the method comprising:
reading in error reports each with at least two error report attachments of different domains;
determining a similarity operator for at least two of the different domains to determine a similarity between error report attachments of the same domain;
determining similarity values of the error report attachments of the same domain by comparing individual error report attachments of the same domain from different error reports by the determined similarity operator; and
grouping the error reports into the at least two error report groups of different error situations based on the determined similarity values.

2. The method according to claim 1, wherein the similarity values are compared with a grouping logic in order to group the error reports into the at least two error report groups.

3. The method according to claim 1, wherein, determining the similarity values comprises comparing error report attachments of already grouped error reports with read-in error report attachments of not yet grouped error reports by the respective determined similarity operator.

4. The method according to claim 1, wherein the error reports are multimodal and the different domains have different media formats.

5. The method according to claim 4, wherein the different media formats include one or more of an image file, video file, audio file, text file, error message, log file, and/or stack trace.

6. The method according to claim 5, wherein the different media formats include at least the image file and/or the video file, and wherein the image file is a screen capture of a test sequence for the error report at an error output time and/or the video file is a screen recording of the test sequence for the error report.

7. The method according to claim 1, wherein the error report attachments of different domains comprise text files of different text formats.

8. The method according to claim 1, wherein at least one group-based metric is determined for each of the error report groups.

9. The method according to claim 1, wherein the method further comprises summarizing the error reports of at least one of the error report groups into a group error report.

10. The method according to claim 1, wherein the method further comprises determining an error criticality of the error report groups and prioritizing the error report groups according to the determined error criticality.

11. The method according to claim 1, comprising using machine learning to determine a respective similarity operator in determining the similarity values and/or in grouping the error reports.

12. A non-transitory computer-readable medium having processor-executable instructions stored thereon, wherein the processor-executable instructions, when executed by one or more processors, facilitate performance of the method according to claim 1.

13. A group-forming system, non-transitory computer-readable medium according to claim 12 and a processor connected thereto, wherein the processor is configured to execute the processor-executable instructions of the non-transitory computer-readable medium.

14. The group-forming system according to claim 13, further comprising at least one interface to at least one test system, wherein the at least one test system is configured to generate error reports each having at least two error report attachments of different domains.

15. The method according to claim 8, wherein the at least one group-based metric is a ratio of a number of log files of one of the error situations to a total number of log files.
